(19) United States
(12) Patent Application Publication
(10) Pub. No.: US 2014/0184382 A1
(43) Pub. Date: Jul. 3, 2014

(54) FALL DETECTION AND PROTECTION SYSTEM AND METHOD

(71) Applicant: National Chiao Tung University, Hsinchu (TW)

(72) Inventors: Bing-Shiang Yang, Hsinchu (TW); Cheng-Wei Lin, Hsinchu (TW)

(73) Assignee: National Chiao Tung University, Hsinchu (TW)

(21) Appl. No.: 14/090,704

(22) Filed: Nov. 26, 2013

(30) Foreign Application Priority Data
Jan. 3, 2013 (TW) 102100082

(51) Int. Cl. G05B 1/00

(52) U.S. Cl. CPC G05B 1/00
USPC 340/3.1

(57) ABSTRACT

The invention provides a fall detection and protection system and method. The fall detection and protection system includes a guarding device to be worn on a user, and a portable device having a pre-determined threshold value stored therein for detecting an activity of a user to acquire an activity status value, which is to be compared with the threshold value so as to detect and determine whether the user falls. When a fall is detected, the portable device transmits a triggering signal to the guarding device to activate the guarding function of the guarding device, thereby preventing the user from injury caused by the impact and collision of a fall.

### BACKGROUND OF THE INVENTION

1. Field of the Invention

The present invention relates to a design for fall protection, and more particularly, to a fall detection and protection system and a fall detection and protection method.

2. Description of Related Art

Falls are dangerous to the aged population as they can adversely affect health. Statistically, the risk of falling increases with age and two-thirds of those who experience a fall will fall again within six months. A decrease in bone density contributes to falls and resultant injuries, and failure to exercise regularly results in poor muscle tone, decreased strength, and loss of bone mass and flexibility. Therefore, falls are detrimental events for the aged population, such that it is important to develop an accurate and reliable fall detection. As a result, many fall detection systems have been developed to detect and distinguish falls so as to prevent and minimize the impact and the resultant injury, especially for those elderly who stay home alone.

Fall detection devices have also been developed to provide real-time and proper medical rescue when a user falls. For example, a fall detector is worn on the elderly to detect the user's daily activities and falls in order to provide instant rescue to minimize injury. However, since the current fall protection devices are only capable of issuing warnings after a user falls, a care rather than a precautionary protection is then taken, such that the current fall protection devices fail to reduce the user's injury when the user falls.

Therefore, there exists a need to provide a novel fall protection system and method to overcome the above-mentioned drawbacks.

### SUMMARY OF THE INVENTION

In view of the drawbacks associated with the prior techniques, the invention provides a fall detection and protection system and a fall detection and protection method which are capable of activating the protection mechanism when a user's fall is detected to thereby provide the user with instant protection to minimize injury.

The fall detection and protection system and the fall detection and protection method of the invention include a guarding device and a portable device. The guarding device can be worn on a user and has a guarding function for protection, and the portable device includes a detecting unit, a comparison unit and a triggering unit. The detecting unit detects a daily activity of the user to acquire an activity status value; the comparison unit compares the acquired activity status value with a threshold value pre-stored therein in order to detect and determine a status of the user and whether the user falls; and the triggering unit transmits a triggering signal to the guarding device to activate the guarding function and protect the user from injury.

The fall detection and protection method of the invention includes (1) detecting an activity of the user and acquiring an activity status value by the portable unit carried by the user; (2) comparing the activity status value with a pre-determined threshold value that is pre-stored in the portable device to detect and determine a status of the user; and (3) transmitting a triggering signal from the portable device to the guarding device worn on the user to activate the guarding function for protecting the user from injury when the status of the user indicates a fall.

### BRIEF DESCRIPTION OF THE DRAWINGS

The present invention can be more fully understood by reading the following detailed description of the preferred embodiments, with reference made to the accompanying drawings, wherein:

FIG. 1 is a schematic view showing the fall detection and protection system according to the present invention;

FIG. 2 is a schematic view showing an implementing of the fall detection and protection system according to the present invention; and

FIG. 3 is a flow chart illustrating the fall detection and protection method according to the present invention.

### DETAILED DESCRIPTION OF THE PREFERRED EMBODIMENTS

The following illustrative embodiments are provided to illustrate the disclosure of the present invention, these and other advantages and effects can be understood by persons skilled in the art after reading the disclosure of this specification.

Note that the structures, proportions, sizes depicted in the accompanying figures, as well as the expressions “upper” “upper side” “second” and “first” described throughout the description merely serve to illustrate the disclosure of the specification to allow for comprehensive reading without a limitation to the implementation or applications of the present invention, and does not constitute any substantial technical meaning.

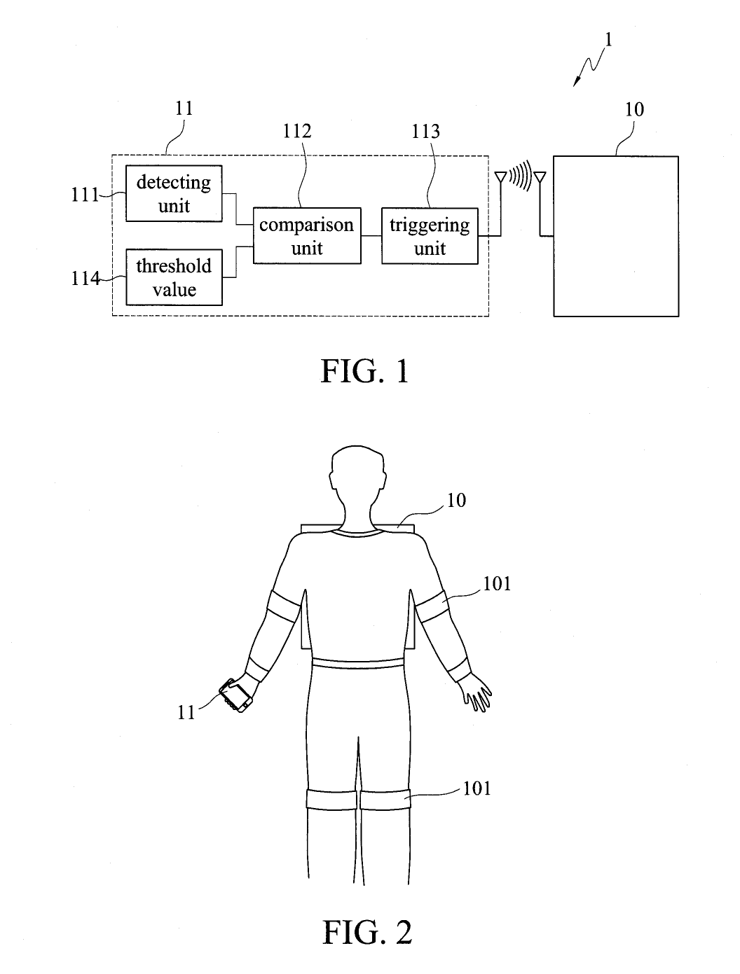

FIG. 1 is a schematic view showing the fall detection and protection system of the present invention. The fall detection and protection system 1 includes a guarding device 10 and a portable device 11 for detecting activities of the user to provide instant protection to the user upon falling. The guarding device 10 is capable being worn on the user and has a guarding function for preventing users from injury upon falling. The portable device 11 includes a detecting unit 111, a comparison unit 112 and a triggering unit 113, wherein the portable device 11 has a predetermined threshold value 114 stored therein, and the predetermined threshold value 114 may be a predetermined and preprogrammed value or a data value acquired from pre-detection of the user's activity status, wherein the activity status value includes an acceleration value, an angular velocity value, or a calculation value resulting from one of the acceleration value and the angular velocity value.

The detecting unit 111 detects activities of the user to acquire an activity status value; the comparison unit 112 compares the activity status value detected by the detecting unit 111 with a predetermined threshold value pre-stored in the portable device 11 to determine a status of the user and whether the user falls; and the triggering unit 113 transmits a triggering signal to the guarding device 10 to activate the guarding function for protecting the user from injury.

FIG. 2 is a schematic view showing an implementation of the invention. In practice, the guarding device 10 is worn on the user, and the user may hold the portable device 11 to activate its guarding function by means of the detecting unit 111 of the portable device 11 that detects the user's activities, so as to obtain an activity status value. The portable device 11 may be a cell phone, a notebook computer, a tablet computer or a personal digital assistance (PDA). The aforementioned portable devices 11 are all equipped with gyros or accelerometers built therein, and therefore the detecting unit 111 of the present invention can also be built in such devices to detect an acceleration value or angular velocity of the user while the user is moving, to obtain the activity status value, wherein the activity status value may include an acceleration value, an angular velocity value or a calculation value resulting from one of the acceleration value and the angular velocity value.

After the activity status value is obtained, the comparison unit 112 of the portable device 11 proceeds to compare the activity status value with the predetermined threshold value 114 of the portable device 11 for detecting and determining whether the user falls, as exemplified in Table 1.

TABLE 1

| | Number | Minimum | Maximum | Average | Standard |
|---|---|---|---|---|---|
| User's | of | value | value | value | deviation |
| activities | activities | (m/s²) | (m/s²) | (m/s²) | (m/s²) |
| Standing to | 10 | 4.17 | 6.57 | 5.76 | 0.73 |
| squatting | | | | | |
| Squatting to | 10 | 4.24 | 6.82 | 5.92 | 0.72 |
| standing | | | | | |
| Standing to | 10 | 6.13 | 7.65 | 6.85 | 0.60 |
| sitting | | | | | |
| Sitting to | 10 | 3.68 | 7.53 | 6.48 | 1.10 |
| standing | | | | | |
| Standing to | 10 | 4.87 | 7.52 | 6.52 | 0.80 |
| lying on | | | | | |
| bed | | | | | |
| Getting up | 10 | 5.67 | 6.89 | 6.27 | 0.40 |
| from bed to | | | | | |
| standing | | | | | |
| Walking | 10 | 5.37 | 6.39 | 5.92 | 0.35 |
| Going | 10 | 4.58 | 6.77 | 5.90 | 0.64 |
| downstairs | | | | | |
| Going | 10 | 6.32 | 8.39 | 7.64 | 0.60 |
| upstairs | | | | | |

Table 1 illustrates the activity status values obtained by the detecting unit 111 in detecting the user's activities. As shown above, the average minimum value is 5.76 m/s², and therefore the threshold value 114 of the portable device 11 may be determined as 5.5 m/s². When the activity status value is compared with the threshold value 114 by the comparison unit 112 of the portable device 11 and is found smaller than the threshold value 114 (defined as 5.5 m/s²), the comparison unit 112 defines the activity corresponding to the smaller activity status value that the user falls, and then the triggering unit 113 transmits a triggering signal, via cable or wireless transmission modes, such as USB, infrared rays, bluetooth or wireless radio frequency technologies, to the guarding device 10, so as to activate the guarding function for protecting the user from injury.

Note that the various activity status values listed above merely serve as an illustration of examples and may vary significantly in view of the differences in user's ages, body types, moving speeds, moving orientations and ranges.

FIG. 2 is a schematic view showing the guarding device 10 including a plurality of wearable guarding units 101 to be worn on different parts of the body of the user, such as elbows and knees, to receive triggering signals for instant protection. For example, the guarding units 101 are self-inflated upon receipt of a triggering signal to buffer and minimize the impact of falling, wherein the triggering signal may be a single triggering signal or a matched signal. When the comparison unit 112 determines that the user falls, the triggering unit 113 transmits a respective triggering signal to each of the guarding units 101 of the guarding device 10 for simultaneously activating the guarding units 101 worn at different parts of the user's body.

After wearing the guarding device 10, the user may match the portable device 11 with the guarding device 10, and both devices may be pre-programmed and pre-matched. Therefore, when the comparison unit 112 determines that the user is going to fall, the triggering unit 113 transmits a triggering signal to the corresponding guarding device 10 to be activated in view of the situation. For instance, if the detecting unit 111 detects that the user is going to fall at the left side, the triggering unit 113 transmits a triggering signal to the guarding device 10 so as to activate the guarding function of the corresponding guarding unit disposed on the user's left side for protecting the user's left elbow and left knee, or only to activate protection for the user's left knee.

While FIG. 2 illustrates a plurality of the guarding units 101 used in this embodiment, the quantity of the guarding units 101 is not limited and shall depend on the actual implementation and requirement.

Further, the guarding device 10 and the guarding units 101 may be designed as one-piece clothes to ensure a whole body protection upon receiving a triggering signal and activating the guarding units 101.

In addition, the guarding device 10 may also include a warning unit (not shown) for issuing a warning signal upon receiving the triggering signal, wherein the warning signal may include sounds, light or vibrations.

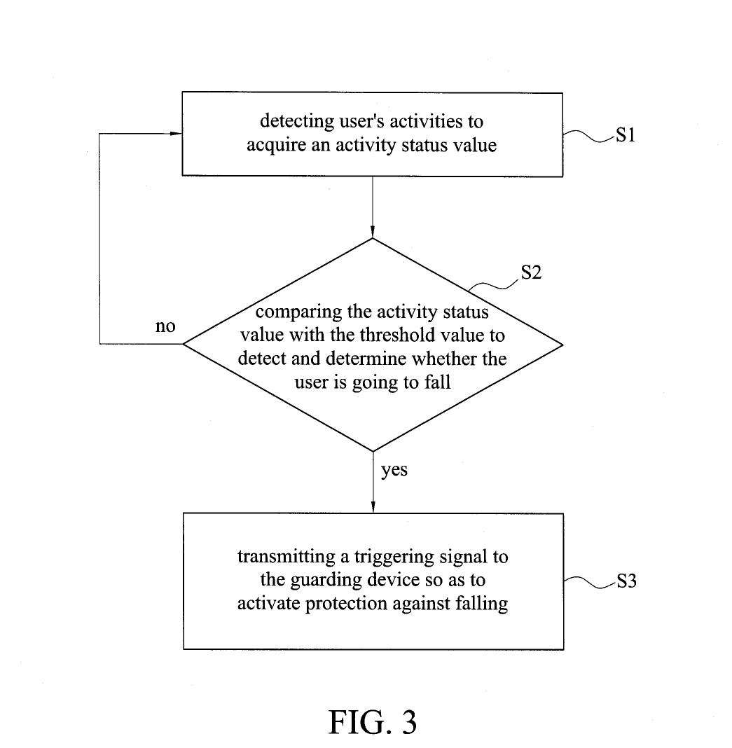

FIG. 3 is a flowchart showing the fall detection and protection method in accordance with the present invention. The detection and protection method includes the following steps. In step S1, the user's activities are detected by a portable device worn on the user to acquire an activity status value, wherein the activity status value includes an acceleration value or an angular velocity value. Then, step S2 is performed. In step S2, the portable device compares the activity status value with a pre-stored threshold value to determine the user's status, and if a fall is not detected, then the procedure returns to step S1 for detecting the user's status. Step S3 is performed upon the detection of a fall. In step S3, when it is detected that the user is going to fall, a triggering signal is transmitted to the guarding device to activate the guarding function for protecting the user. When there are a plurality of guarding units in the guarding device, the guarding device transmits a triggering signal to each of the corresponding guarding units to activate the corresponding guarding units. In addition, when the guarding device further includes a warning unit, the warning unit will be activated to issue warnings upon receiving the triggering signal.

The invention further provides a programmed product having a fall detection and protection program stored therein which is applicable to the portable device to perform the detection and protection method once the program is loaded into the portable device and properly executed.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A fall detection and protection system, comprising:
a guarding device capable of being worn on a user and having a guarding function for reducing impact upon falling; and
a portable device, comprising:
a detecting unit for detecting an activity of the user to obtain an activity status value;
a comparison unit for comparing the activity status value with a pre-determined threshold value to detect and determine a status of the user; and
a triggering unit for transmitting a triggering signal to the guarding device to activate the guarding function when the status of the user indicates a fall.

2. The fall detection and protection system of claim 1, wherein the detecting unit includes an accelerometer or a gyro.

3. The fall detection and protection system of claim 1, wherein the activity status value includes an acceleration value, an angular velocity value, or a calculation value resulting from one of the acceleration value and the angular velocity value.

4. The fall detection and protection system of claim 1, wherein the guarding device further comprises a plurality of guarding units, and the triggering unit transmits a respective triggering signal to each of the guarding units to activate the guarding function.

5. The fall detection and protection system of claim 1, wherein the pre-determined threshold value is pre-set in the portable device or pre-set according to a pre-detected activity status value of the user, and wherein the activity status value includes an acceleration value, an angular velocity value, or a calculation value resulting from one of the acceleration value and the angular velocity value.

6. The fall detection and protection system of claim 1, wherein the portable device transmits the triggering signal to the guarding device by means of a cable or wireless transmission.

7. The fall detection and protection system of claim 6, wherein the wireless transmission includes one of infrared rays, blue tooth and radio frequency identification technologies.

8. The fall detection and protection system of claim 1, wherein the guarding device further comprises a warning unit for issuing a warning when the triggering signal is received by the guarding device.

9. A fall detection and protection method, comprising steps of:
detecting an activity of a user and acquiring an activity status value corresponding to the activity of the user by means of a portable device worn by the user;
comparing the activity status value with a pre-determined threshold value to detect and determine a status of the user by the portable device, and
transmitting a triggering signal by the portable device to a guarding device to activate a guarding function of the guarding device when the status of the user indicates a fall.

10. The fall detection and protection method of claim 9, wherein the activity status value includes an acceleration value, an angular velocity value, or a calculation value resulting from one of the acceleration value and the angular velocity value.

11. The fall detection and protection method of claim 9, wherein the guarding device further comprises a plurality of guarding units, and the triggering unit transmits a respective triggering signal to each of the guarding units to activate the guarding function of the guarding device.

12. The fall detection and protection method of claim 9, wherein the step of transmitting further comprises issuing a warning by the guarding device after the triggering signal is received by the guarding device.

13. A programmed product having a fall protection program stored therein to be loaded in and executed by the portable device for performing the fall detection and protection method of claim 9.
